(19) United States
(12) Patent Application Publication
(10) Pub. No.: US 2010/0069002 A1
(43) Pub. Date: Mar. 18, 2010

(54) METHOD AND APPARATUS FOR A WIRELESS COMMUNICATION DEVICE UTILIZING BLUETOOTH TECHNOLOGY

(75) Inventor: XU XIANG RONG, Shanghai (CN)

Correspondence Address: CHARLES C.H. WU, 98 DISCOVERY, IRVINE, CA, 92618-3105, US

(73) Assignee: VCAN SPORTS, INC.

(21) Appl. No.: 12/211,206

(22) Filed: Sep. 16, 2008

(51) Int. Cl. H04B 7/26

(52) U.S. Cl. 455/41.2

(57) ABSTRACT

A method and an apparatus for a wireless communication device utilizing a Bluetooth technology for use on a helmet is disclosed here. More specifically, a helmet with a cavity within said helmet that allows the Bluetooth transceiver to be easily removable and easily upgradable without changing the external host controller. The method and apparatus is capable of communicating with a cell phone, communicating with a second helmet, communicating with an audio device, communicating with a global positioning system, and communicating with two or more Bluetooth transceivers all within one unit.

### BACKGROUND OF THE INVENTION

1. Technical Field of the Invention

The present invention relates in general to a wireless communication device utilizing Bluetooth technology. More specifically, the present invention relates to a helmet incorporating a Bluetooth transceiver within a cavity of the helmet that allows a complete integration of all Bluetooth compatible devices while being easily upgradable without the need to replace the helmet itself.

2. Description of the Related Art

Helmets have been used for a variety of reasons in various industries to protect the safety of the operator. Helmets, when correctly used, have been known to dramatically reduce the risk of injury to the cranial and neck areas of the operator. A helmet finds its use in various types of industries including motorcycle operation, vehicle operation, construction site operation, military operation, law enforcement operations, security operations, logistic operations, professional sports operations, and many other operations wherein the operator needs to be protected from cranial and neck injuries.

With the gradual development of the helmets, and the increasing need for their use within various industries, helmets have developed to be more versatile. Modern day helmets are capable of various additional tasks in addition to providing protection to the cranial and the neck. Some helmets offer a competitive advantage over standard helmets by having a flashlight built into the forehead area to allow better night vision. Other helmets are capable of an external camera attachment to allow the recording of the operator's line of sight.

One of the most common, and most desirable capabilities incorporated with a helmet is the ability to communicate wirelessly with different individuals. For example, many racecar drivers wirelessly communicate with their pit crew via a communication device incorporated into their helmets. The ability to communicate wirelessly with an operator wearing a helmet often involves the use of Ultra High Frequency (UHF) and required heavy burdensome attachments in the past. These heavy and burdensome components decrease the aesthetic appearance of the helmet and can often impair the operator from properly performing his or her task.

With the advancement of UHF two-way radio frequency technology, the various wireless communication devices that utilize UHF two-way radio frequency have been shrinking in size. The reduction in size has allowed more portability, which has increased industry demand for helmets that are capable of wireless communication. Various industries such as the motorcycle industry, bicycle industry, construction industry, police security industry, or even football industry all utilize the now reduced sized UHF wireless communication technology. However, UHF two-way radio frequency technology suffers from a major drawback in that it can be unsecure and can easily be intercepted. Moreover, radio frequencies are incapable of higher level wireless communication that allows the operator to communicate with various electronic devices such as audio devices or a global positioning system device.

In order to address the need for helmets to wirelessly communicate with various electronic devices, Bluetooth technology has been developed that allows the usage of short range radio frequency in the ranges of 2.4 GHz and in a low frequency to connect to various electronic devices and exchange information. The various devices could include mobile phones, telephones, laptops, personal computers, printers, global positioning receivers, digital cameras, automobile sound systems, or any other electronic components.

Bluetooth technology, although addressing the flaws and deficiencies of the UHF two-way radio technology, still has some flaws in its incorporation into the helmet industry. Bluetooth technology, although capable of communicating with various components separately, has never been incorporated into a singular device capable of communication with all the various electronic components that utilize Bluetooth technology. Moreover, advancements in the helmet industry are even slower with the recognition of the need for Bluetooth technology in helmets.

Although there are some attempts to utilize Bluetooth technology in the helmet industry, those attempts have not been able to provide a system that is capable of interfacing with various electronic components such as a cell phone, a second helmet, an audio device, a global positioning system and the likes. Moreover, these attempts at utilizing Bluetooth technology within the helmet industry have the components installed directly into the helmets themselves, making it impossible to update the Bluetooth components without replacing the entire host helmet itself.

Hence, it can be seen, that there is a need for a wireless communication device such as a helmet that is capable of eliminating bulky attachments, capable of utilizing Bluetooth technology to communicate with various electronic devices, and packaged within the helmet itself to improve aesthetic appeal.

### SUMMARY OF THE INVENTION

To minimize the limitations found in the prior art, and to minimize other limitations that will be apparent upon the reading of the specifications, the present invention provides an apparatus for a wireless communication device utilizing a Bluetooth technology for use on a helmet comprising of a cavity located within the helmet, a Bluetooth transceiver located in the cavity of said helmet, and an external host controller connected to the Bluetooth transceiver to provide a command to the Bluetooth transceiver; wherein the Bluetooth transceiver is configured for future upgrades without changing the external host controller.

In another aspect of the present invention, a method in accordance with the present invention is a method of wireless communication using Bluetooth technology via a helmet comprising of removably placing a Bluetooth transceiver within a cavity of the helmet, deriving a command to the Bluetooth transceiver from an external host controller connected to the Bluetooth transceiver; wherein the external host controller is located within an external shell of the helmet, and configuring the Bluetooth transceiver for future upgrades without changing the external host controller.

One objective of the invention is to provide a wireless communication device within a helmet utilizing Bluetooth technology that is not bulky and burdensome.

Another objective of the invention is to provide a wireless communication device within a helmet that is capable of being incorporated into the interior walls of the helmet to improve aesthetic appeal.

A third objective of the invention is to provide a wireless communication device within a helmet that is capable of communication with various electronic components such as an audio device, a cell phone, a global positioning system, or any other system capable of using Bluetooth technology

Yet another objective of the present invention is to provide a wireless communication device within a helmet that is capable of providing the Bluetooth transceiver in an easily removable manner distinct from the host helmet itself.

It is also the objective of the present invention to provide a transport layer that is capable of exchanging information without knowledge of the intimate data.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a prospective view of the present invention showing the external host controller;

FIG. 2 is a bottom view of the present invention showing the Bluetooth transceiver;

FIG. 3 is a bottom view of the present invention showing cavity with the Bluetooth transceiver removed; and

FIG. 4 is a block diagram providing an overview of the software layers within the Bluetooth transceiver.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

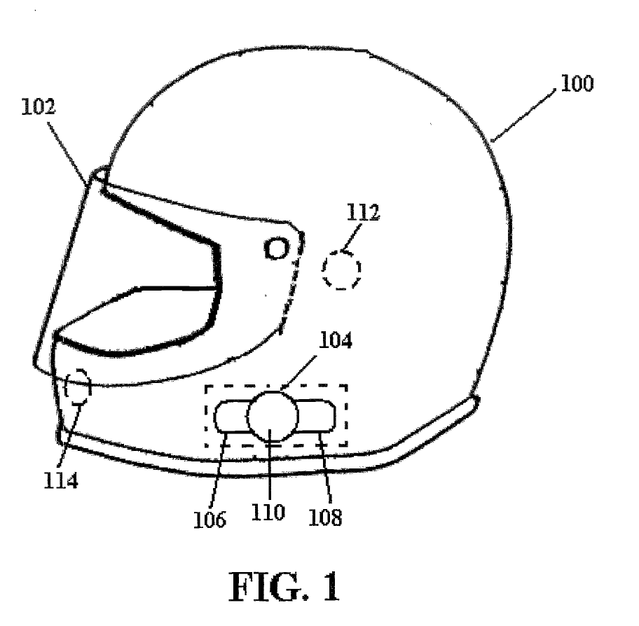

FIG. 1 shows an overall prospective view of a helmet in accordance with the present invention.

Helmet 100 is shown in FIG. 1, with a faceshield 102, an external host controller 104 connected to an external surface of the helmet 100. The external host controller 104 has a volume down button 106 and a volume up button 108 in addition to a central scroll wheel button 110. Finally, helmet 100 further comprises of a pair of speakers 112 and a microphone 114 located within helmet 100.

Helmet 100, although shown as a full face motorcycle helmet in this current exemplary embodiment, may be an open faced motorcycle helmet, a bicycle helmet, an automotive helmet, a law enforcement helmet, a military helmet, a construction helmet, a sports protective helmet, or any other types of helmets that provide cranial and neck protection without departing from the scope of the present invention. Moreover, although helmet 100 may be made out of a polystyrene or polypropylene foam as the most common material, helmet 100 may also be made out of polycarbonate plastic, fiberglass, Kevlar, or any other material capable of offering protection to the cranial and neck areas all without departing from the scope of the present invention.

Faceshield 102 in the present invention may generally be an important feature in a closed faced motorcycle helmet, as it offers protection from debris during motorcycle operation. However faceshield 102 is often not required in many open faced helmets, bicycle helmets, law enforcement helmets, or any other form of helmets offering protection for the cranial and neck area of the operator. Faceshield 102 can be removed without affecting the overall functionality of the present invention with helmet 100, and need not be present without departing from the scope of the present invention.

External host controller 104 in the present invention may be located at an external wall of helmet 100 to provide ease of access for the operator; however external host controller 104 may be placed at any location within the helmet 100, or connected remotely to helmet 100 all without departing from the scope of the present invention so long as it provides a connection to helmet 100. External host controller 104 in the present invention may be comprised of three physical buttons, a volume down button 106, a volume up button 108, and a central scroll wheel button 110; however external host controller 104 may comprise of any other variations of buttons that achieve the same controlling objectives without departing from the scope of the present invention.

Volume down button 106 in the present invention may be used to receive a command from an operator such as decreasing the volume within speakers 112 that are located within helmet 100. Volume down button 106 may also be used to control various other options of helmet 100 such as decreasing display brightness, decreasing voice command sensitivity, or any other features that could be desirable within such a Bluetooth wireless communication system without departing from the scope of the present invention.

Volume up button 108 in the present invention may function the same way as volume down button 106. Volume up button 108 may also be used to control various other options of helmet 100 such as increasing display brightness, increasing voice command sensitivity, or any other features that could be desirable within such a Bluetooth wireless communication system without departing from the scope of the present invention.

Scroll wheel button 110 in the present invention may be used for receiving a separate command from an operator in addition to volume down button 106 and volume up button 108. Scroll wheel button 110 in the current exemplary embodiment may receive a command from an operator in the form of a depression motion, or in the form of a rotational motion all without departing from the scope of the present invention. Scroll wheel button 110 may also be replaced with any other sort of buttons that could be capable of receiving an additional command from the operator all without departing from the scope of the present invention.

FIG. 1 also shows a pair of speakers 112 in accordance with an embodiment of the present invention that may be embedded within the inside of helmet 100. For the purpose of illustration, only one speaker 112 is shown on the left side of helmet 100 near a left ear of the operator, the corresponding speaker 112 may be located on the same location on the right side of helmet 100 near the other ear of the operator.

Finally, FIG. 1 shows a microphone 114 located near the front of the helmet to allow receipt of a voice command from the operator. Microphone 114 in this current exemplary embodiment may be located near the front of helmet 100 for its proximity location with the mouth of the operator; however, Microphone 114 may be placed at any other location within helmet 100 so long as it is able to pick up the voice command of the operator without departing from the scope of the present invention. In addition to receiving a voice command, microphone 114 may also be used for two-way communication without departing from the scope of the present invention.

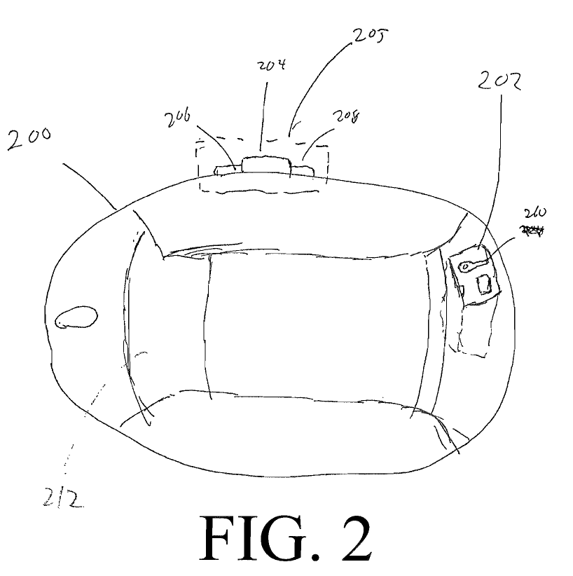

FIG. 2 shows a bottom view of the current invention showing the location of the cavity of the Bluetooth transceiver.

FIG. 2 shows helmet 200, along with the location of the Bluetooth transceiver 202. External host controller 205 comprising of scroll wheel button 204, along with volume down button 206, and volume up button 208 as described previously in FIG. 1 are also shown here. Finally, FIG. 2 shows a charging receptacle 210 to connect the Bluetooth transceiver 202 to a power source.

Helmet 200 here in FIG. 2, corresponds to helmet 100 shown in FIG. 1, but the bottom view enables the Bluetooth transceiver 202 position to be shown. Bluetooth transceiver 202 in the current embodiment may be located towards the rear of helmet 200, as it provides a convenient location for such a Bluetooth transceiver within helmet 200. However, Bluetooth transceiver 202 may be located at any alternative position within helmet 200 so long as it can be physically placed in the helmet without departing from the scope of the present invention.

Bluetooth transceiver 202 in the current exemplary embodiment may serve to receive the command from the external host controller 205, which is embedded into helmet 200. Bluetooth transceiver 202 as shown in the current exemplary embodiment, being a separate detached unit from helmet 200 and external host controller 205 allows the Bluetooth transceiver 202 to be upgraded to accommodate the latest development in Bluetooth technology without the need to change the helmet 200 or the external host controller 205.

Bluetooth transceiver 202 in the present invention is fully integrated with various software and hardware levels that allow the current Bluetooth transceiver to effectively and seamlessly communicate with various Bluetooth enabled components. Bluetooth transceiver 202 in the current exemplary embodiment may be capable of communicating with a cell phone, communicating with a second helmet, communicating with an audio device, communicating with a global positioning system, recognizing a voice prompt command, communicating with two or more external Bluetooth transceivers, and any other types of Bluetooth enabled functionality all without departing from the scope of the present invention.

More specifically, Bluetooth transceiver 202 in the present invention's capability of communicating with an audio device extends to the ability to relay audio outputs via an XM radio capable device towards Bluetooth transceiver 202.

With respect to Bluetooth transceiver 202's communication capabilities with a global positioning system, the current exemplary embodiment allows helmet 200 to receive an audio prompt from the global positioning system. Moreover, Bluetooth transceiver could also allow the visual display from the global positioning system to be displayed within a faceshield 212 of helmet 200.

Finally, as it can be seen from FIG. 2, Bluetooth transceiver 202 may have a dedicated electrical charging receptacle 210 showing from the outer surface of Bluetooth transceiver 202, which allows ease of recharge of the Bluetooth transceiver 202 without removing it from the helmet 200. However, electrical charging receptacle 210 need not be present in all various embodiments of the present invention, and Bluetooth transceiver 202 may derive its power from various other sources some of which may or may not require an electrical charging receptacle 210 all without departing from the scope of the present invention.

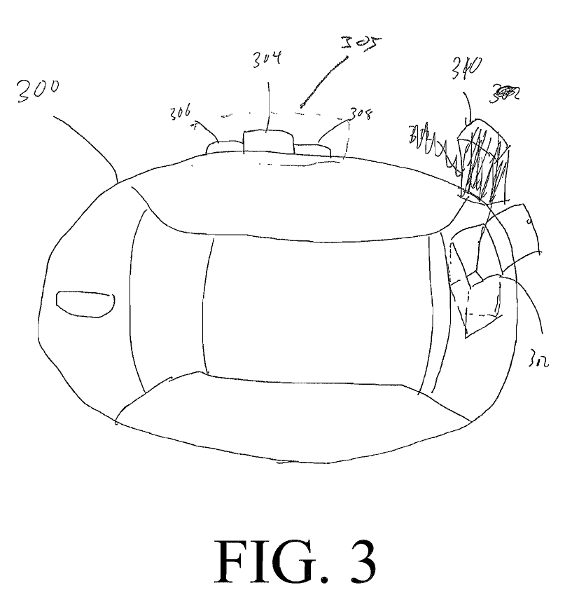

FIG. 3 shows an exploded bottom view of the present invention with the Bluetooth transceiver 310 removed from its cavity within helmet 300. As it can be seen from the current exemplar embodiment shown in FIG. 3, Bluetooth transceiver 310 may be removably detached from helmet 300. Bluetooth transceiver 310, being removable from helmet 300 is advantageous when compared to built in Bluetooth transceiver because the removability allows upgrades to the transceiver without the need to change out helmet 300 itself.

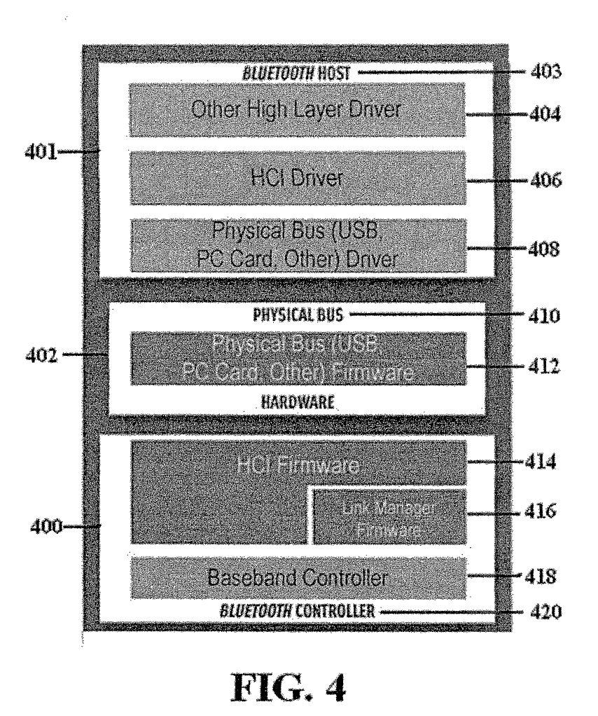

FIG. 4 shows in more detail, the software and hardware layers of the Bluetooth transceiver 400 in a block diagram format.

Host Controller Interface (HCI) firmware 414 in the present invention implements the HCI commands for the Bluetooth transceiver 400 by accessing a baseband command, a link manager command, a hardware status register, a control register, or even an event register. These commands are generally provided from an external host controller 401, as various commands are received from an operator.

Host control transport layer 402 is located between the HCI firmware 414 on the Bluetooth transceiver 400 and the HCI driver 406 on the external host controller 401. The host control transport layer 402 allows the Bluetooth transceiver 400 and the external host controller 401 to transfer data without intimate knowledge of the data. This host control transport layer 402 provides a transparency that is independent of the underlying transport technology, and does not require any visibility into the data that the external host controller 401 passes to the Bluetooth transceiver 400. This transparency of the host control transport layer provides the ability for the external host controller 401 to communicate and exchange information with the Bluetooth transceiver 401 without any intimate knowledge of the data.

This transparent host control transport layer 402 will allow ease of upgrade of Bluetooth transceiver 401 without the need to change out the external host controller 401 because the communication between the two devices are not data specific. Consequently, any sort of information may be transported between the two devices without the need for additional modification.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A wireless communication device utilizing a Bluetooth technology for use on a helmet comprising:
a cavity located within said helmet;
a Bluetooth transceiver located in said cavity of said helmet; and
an external host controller connected to said Bluetooth transceiver to provide a command to said Bluetooth transceiver;
wherein said Bluetooth transceiver is configured for future upgrades without changing said external host controller.

2. The wireless communication device of claim 1, wherein said external host controller is located within an external shell of said helmet.

3. The wireless communication device of claim 2, wherein said Bluetooth transceiver is removably inserted into said cavity of said helmet.

4. The wireless communication device of claim 3, wherein said command is derived from an operator via an input from said external host controller.

5. The wireless communication device of claim 4, wherein said command further comprises of a baseband command, a link manager command, a hardware status register, a control register, and an event register.

6. The wireless communication device of claim 4, further comprising:
a host control transport layer between said Bluetooth transceiver and said external host controller; wherein said host transport layer is transparent.

7. The wireless communication device of claim 6, wherein said host control transport layer allows said Bluetooth transceiver to communicate directly with a second Bluetooth transceiver without the need of an additional component.

8. The wireless communication device of claim 7, wherein said Bluetooth transceiver allows said helmet to communicate with a cell phone.

9. The wireless communication device of claim 7, wherein said Bluetooth transceiver allows said helmet to communicate with a second helmet.

10. The wireless communication device of claim 7, wherein said Bluetooth transceiver allows said helmet to communicate with an audio device.

11. The wireless communication device of claim 10, wherein said audio device is capable of receiving an XM radio signal.

12. The wireless communication device of claim 6, wherein said Bluetooth transceiver allows said helmet to communicate with a global positioning system device.

13. The wireless communication device of claim 12, wherein said Bluetooth transceiver allows said helmet to relay an audio prompt from said global positioning system device within a speaker located inside said helmet.

14. The wireless communication device of claim 13, wherein said Bluetooth transceiver allows said helmet to display a visual map from said global positioning system device within a faceshield located inside said helmet.

15. The wireless communication device of claim 7, wherein said Bluetooth transceiver recognizes a voice prompt from a microphone located within said helmet to activate said Bluetooth transceiver.

16. The wireless communication device of claim 7, wherein said Bluetooth transceiver is capable of communicating with two or more external Bluetooth transceivers.

17. A method of wireless communication using a Bluetooth technology within a helmet comprising:
removably placing a Bluetooth transceiver within a cavity of said helmet;
deriving a command to said Bluetooth transceiver from an external host controller connected to said Bluetooth transceiver, wherein said external host controller is located within an external shell of said helmet; and
configuring said Bluetooth transceiver for future upgrades without changing said external host controller.

18. The method of wireless communication of claim 16, further comprising:
juxtaposing a host control transport layer between said Bluetooth transceiver and said external host controller; wherein said host transport layer is transparent.

19. The method of wireless communication of claim 18, further comprising:
directly communicating between said Bluetooth transceiver and a second Bluetooth transceiver utilizing said host control transport layer without the need for an additional component.

20. The method of wireless communication of claim 19, wherein said Bluetooth transceiver allows said helmet to communicate with a cell phone, a second helmet, an audio device, a global positioning system device, and recognizes a voice prompt from a microphone located within said helmet to activate said Bluetooth transceiver.
